(19) United States
(12) Patent Application Publication
(10) Pub. No.: US 2024/0144238 A1
(43) Pub. Date: May 2, 2024

(54) SYSTEM AND METHOD FOR FACILITATING SERVICE MACHINE ACTIVATION

(71) Applicant: Capital One Services, LLC, McLean, VA (US)

(72) Inventors: Kevin OSBORN, New York, NY (US); Jeffrey RULE, Chevy Chase, MD (US)

(21) Appl. No.: 17/977,766

(22) Filed: Oct. 31, 2022

(51) Int. Cl. G06Q 20/34; G06Q 20/40

(52) U.S. Cl. CPC G06Q 20/352; G06Q 20/40145; G06Q 20/405

(57) ABSTRACT

In an automated method for authorizing an automated service, a service facilitation system receives a service from an account holder user device associated with a card account and a card account vicinity card. The service request identifies an automated service machine (ASM) and a service to be provided by the ASM. The service facilitation system transmits a service request notification to the requested ASM. The service facilitation receives from the ASM, card authentication information that includes an encrypted authentication block received by the ASM from a presented vicinity card. The service facilitation system uses the card authentication information to verify that the presented vicinity card is the card account vicinity card and determines a service authorization result for the requested service. The service facilitation then transmits a service authorization response based, at least in part, on the service authorization result.

### FIELD OF THE INVENTION

This application relates generally to the use of intermediate range field communication systems, and in particular, to a system and method for using a vicinity card to initiate an action of an automated service machine.

### BACKGROUND OF THE INVENTION

More and more ordinary daily activities involve the use of data processors to initiate machine-controlled actions. Such actions can include the activation of an appliance or machinery by a private individual or a company employee via the Internet or other network. They can also include activation of commercially operated machines that automatically provide financial and other services. As the number of network-based actions increase, the likelihood of fraudulent activity also increases. At the same time, the desire for initiating machine-controlled services without physical interaction has dramatically increased. The use of near field communication (NFC), has reduced physical interaction to some degree, but to many, the up-close physical interaction required by NFC is too close.

### SUMMARY OF THE INVENTION

An illustrative aspect of the invention provides an automated method for authorizing an automated service. The method comprises receiving, by a service facilitation data processing system from an account holder user device, a service request including identification of an automated service machine (ASM) and a service to be provided by the ASM. The account holder user device is associated with a card account and a card account vicinity card. The method further comprises transmitting, by the service facilitation data processing system to the ASM, a service request notification including a card account identifier associated with the vicinity card and requested service information. The method still further comprises receiving, by the service facilitation data processing system from the ASM, card authentication information. The card authentication information includes an encrypted authentication block received by the ASM from a presented vicinity card. The service facilitation data processing system uses the card authentication information to verify that the presented vicinity card is the card account vicinity card and determines a service authorization result for the requested service. The method also comprises transmitting, by the service facilitation data processing system to the ASM, a service authorization response based, at least in part, on the service authorization result.

Another aspect of the invention provides a service facilitation data processing system for facilitating a service transaction on a vicinity card account at one of a plurality of automated service machines (ASMs). The system comprises a communication interface, a service request data processor, and an authentication data processor. The communication interface is configured for selective communication with any of the plurality of ASMs via a first network and an account holder user device associated with the vicinity card account via a second network. The service request data processor is configured to receive, from the account holder user device, a service request including identification of a requested ASM and a service to be provided by the requested ASM. The requested ASM is one of the plurality of ASMs. The service request data processor is further configured to transmit, to the requested ASM, a service request notification that includes requested service information and a card account identifier associated with the vicinity card account and a card account vicinity card. The authentication data processor is configured to receive, from the requested ASM, card authentication information received by the ASM from a presented vicinity card. The authentication data processor is further configured to verify that the presented vicinity card is the card account vicinity card and determine a service authorization result for the requested service. Responsive to determining a positive service authorization result, the authentication data processor transmits an instruction to the requested ASM to initiate the requested service.

Another aspect of the invention provides an automated method of providing an automated service. The method comprises receiving, by an ASM from a service facilitation data processing system, a service request notification that includes a card account identifier associated with an account holder device and a vicinity card and requested service information. The method further comprises establishing, by the ASM, contactless communication with a presented vicinity card and receiving, by the ASM from the presented vicinity card, presented card information that includes a presented card identifier and an encrypted authentication block. The method still further comprises transmitting, by the ASM to the service facilitation data processing system, a service authorization request including at least a portion of the presented card information including the encrypted authentication block. The method also comprises receiving, by the ASM from the service facilitation data processing system an authorization response and, responsive to receiving a positive authorization response, initiating the requested service by the ASM.

### BRIEF DESCRIPTION OF THE DRAWINGS

The invention can be more fully understood by reading the following detailed description together with the accompanying drawings, in which like reference indicators are used to designate like elements, and in which:

FIG. 1 is a schematic representation of a service transaction processing system according to an embodiment of the invention;

FIG. 2 is a sequence diagram illustrating an automated service provision scenario that makes use of one or more embodiments of the invention;

FIG. 3 is a schematic representation of an automated service machine and a smart transaction card usable in conjunction with embodiments of the invention;

FIG. 4 is a schematic representation of a data processing chip of a smart transaction card according to an embodiment of the invention;

FIG. 5 is a schematic representation of a user data processing system usable in conjunction with embodiments of the invention;

FIG. 6 is a schematic representation of a service facilitation data processing system according to an embodiment of the invention;

FIG. 7 is a block diagram of an automated method of authorizing an automated service according to an embodiment of the invention; and

FIG. 8 is a block diagram of an automated method of providing automated service according to an embodiment of the invention.

### DETAILED DESCRIPTION OF THE INVENTION

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It is also to be understood that the mention of one or more method actions does not preclude the presence of additional method actions or intervening method actions between those actions expressly identified. Similarly, it is also to be understood that the mention of one or more components in a device or system does not preclude the presence of additional components or intervening components between those components expressly identified.

The present invention provides systems and methods for authorizing and facilitating the use of an automated service machine without the need for close interaction between the user and the machine. As used herein, the term “automated service machine” or “ASM” means a network-enabled machine that can verify user authorization, communicate with one or more remote administrative processing systems, and provide an automated service to the user. The invention is usable for any automated service, but may be particular useful in relation to purchased service and financial services. In some embodiments, for example, the methods of the invention may be used to activate an automated car wash or a key cutting machine. In other embodiments, the invention may be implemented through an automated teller machine (ATM) or a machine configured for receiving coins and returning paper money. In some embodiments, an ASM may be an automated product or service vending machine. The invention may provide a user experience in which an automated service is initiated or completed immediately upon the user approaching the ASM or ASM communication interface, in some cases, with no additional user action whatsoever.

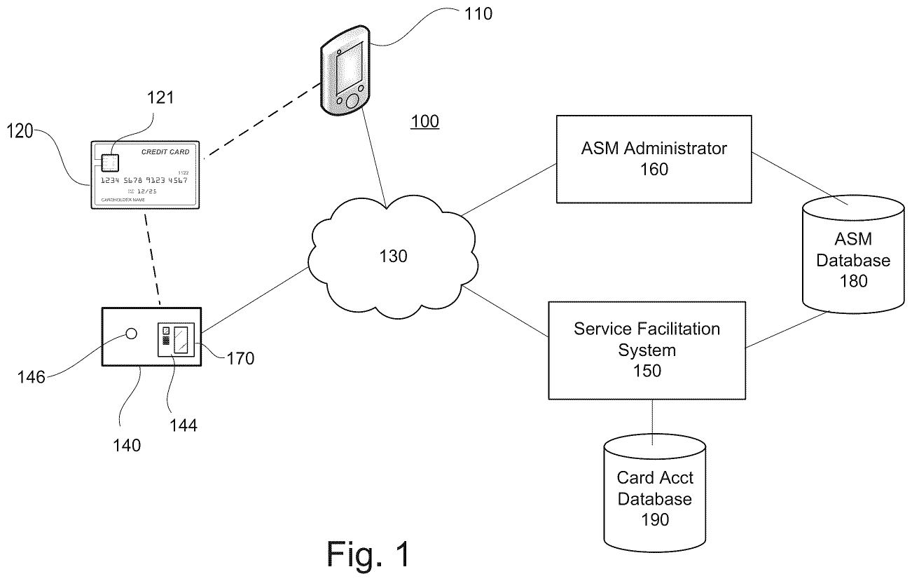

With reference to FIG. 1, methods of the invention can be implemented on or in conjunction with a service transaction processing system 100 that incorporates and manages one or more automated service machines (ASMs) and is established to authenticate and process action/service requests associated with a user or a user account. The action or service requested may be of any form that is at least partially implemented on or initiated by a digitally controlled machine. The system 100 may include a number of network-enabled computer systems, including, as depicted in FIG. 1, one or more user devices 110, one or more ASMs 140, an ASM administrator 160, and a service facilitation data processing system 150. Any or all of these system elements may be capable of communication with one another via a communication network 130. In some embodiments, certain components of the system 100 may communicate with one another via a second network in addition to or instead of the network 130.

As used herein, the term “automated service machine” or “ASM” means a network-enabled machine that can receive an action or service request, verify user authorization, communicate with a central action processing system, and implement the requested action or service. In some embodiments, the ASM 140 may be a remotely controlled machine or appliance that can be activated by authorized personnel using remote code entry. In particular embodiments, the ASM 140 may be an ordinary merchant transaction processing and the requested action may be the processing of an account-related transaction. In some embodiments, the ASM 140 may be configured for processing card-based purchase or other monetary transaction. In some embodiments, the ASM 140 may be a machine configured for carrying out a cash-related service. This could be, for example, an automated teller machine (ATM) or a machine configured for receiving coins and returning paper money. In some embodiments, an ASM may be an automated product or service vending machine that is configured for carrying out an account-based transaction in addition to its ordinary dispensing function.

As will be discussed in more detail, the ASM 140 may be provided with a radio frequency identification (RFID) reader capable of intermediate range communication with compatible passive RFID transmitters. As used herein, the term “intermediate range” (or “vicinity range”) refers to passive, field-based communication limited to about 1.5 m. of separation, and is used to distinguish near field communication (NFC), which is typically limited to a range of about 10 cm. Intermediate range communication technology may be used in what are often referred to as “vicinity cards” (as opposed to “proximity cards”, which are used for NFC). Vicinity cards typically make use of a passive transmitter configured to operate in accordance with ISO/IEC 15693, which specifies an operating frequency of 13.56 MHz. As will be discussed, the present invention provides for incorporating this capability into a transaction or other smart card 120. The use of intermediate communication range technology allows the ASM 140 to receive information from the card 120 at a distance sufficiently limited to provide security, but long enough to make close contact between the ASM 140 and the card user is unnecessary.

The ASM administrator system 160 may be or include a network-enabled processing system that is configured for receiving action requests and/or other action-related information from the ASM 140 or from a user device 110. The ASM administrator system 160 may be further configured for processing a user or account-related action request and transmit action-related instructions to the requesting ASM 140 or user device 110. In certain embodiments, for example, the action request may be or include a request to process a purchase or other financial transaction using a user financial account. In such embodiments, the ASM administrator system 160 may be configured to verify account information and authorization for the requested transaction, post the transaction to the account, and transmit instructions to the requesting device to complete the transaction. The ASM administrator system 160 may also be configured to receive a service request or notification from the service facilitation system 150 and relay it to an appropriate ASM 140. It may also be configured to relay ASM administrator 160 service validation information and/or service initiation instructions from the service facilitation system 150 to the ASM 140.

The service facilitation data processing system 150 may be or include one or more network-enabled data processors configured for communication with one or more user devices 110 and one or both of the ASM 140 and the ASM administrator system 160 via the network 130. The service facilitation system 150 may include or be in communication with a card account database 190 containing account and account holder/user information records. The service facilitation system 150 may be configured to receive a service request from the ASM 140 user device 110, transmit the request to a requested ASM 140 or to the ASM administrator system 160. The service facilitation system 150 may be further configured to receive a positive or negative validation response from the user device 110 and to transmit an appropriate “process” or “deny” response to the validation requestor.

A user processing device 110 may be any data processing and/or communication device that an account holder uses to carry out an action and/or to communicate with an ASM 140, an action processing authority (e.g., ASM manager system 160), or the service facilitation system 150 including, but not limited to a smartphone, a desktop computer, a laptop computer, and a tablet. As will be discussed in more detail hereafter, the user devices 110 may each be configured to transmit an action or service request to the service facilitation system 150 and receive and respond to validation requests from the service facilitation system 150. In typical embodiments, the user processing device 110 is a mobile device having a location service application.

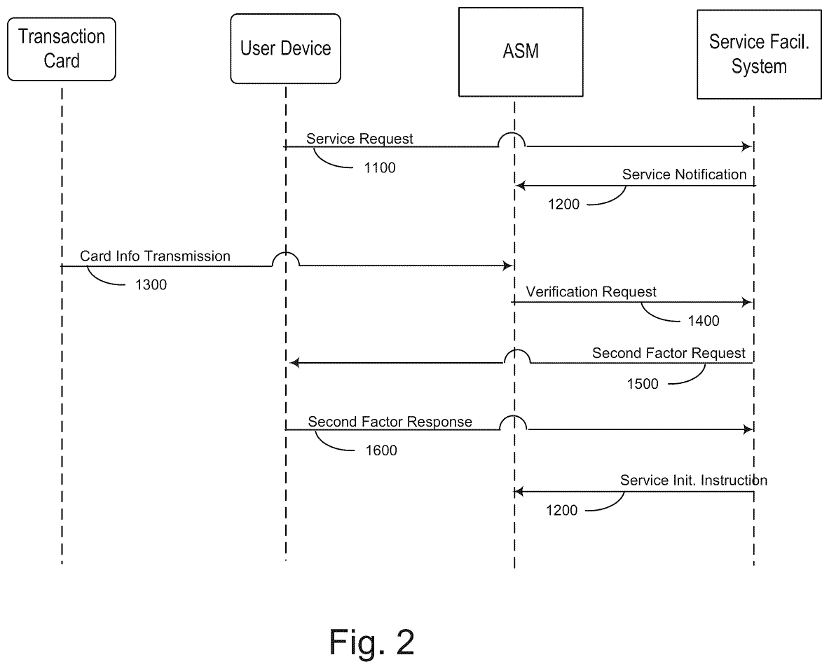

With reference now to FIG. 2, a typical ASM service initiation scenario will be described. In this scenario, a prospective service user has an account associated with a vicinity range communication-equipped transaction card and an account holder user device. The account holder uses an application on the account holder user device to enter a request for a service to be provided by a particular ASM. The service request may include information identifying the ASM and specifying one or parameters of the requested service. In some embodiments, the request may specify a time interval within which the user will arrive at the ASM to receive the service. At 1100, the user device transmits the service request to a service facilitation system, which may be associated with the account and/or the application on the user device. The service facilitation system may verify authorization of the user device/user to make the service request. At 1200, the service facilitation system transmits a service notification to the requested ASM. In some embodiments, the notification may be transmitted to the ASM via an ASM administrator system. The service notification may include some or all of the information included in the service request. It may also include information associated with the transaction card. When the user wishes to initiate the service, the user brings the transaction card and the user device to the location of the ASM. When the user comes to within the intermediate communication range, the on-board processor of the transaction card is activated and, at 1300, the card transmits card information to the ASM. The card information may include a card identifier and/or other information. In particular embodiments, the card information may include card processor-encrypted information that can be used to validate the request. Depending on the embodiment, the ASM may use the card information to match up the card to a previously received service request information. In some embodiments, if a service request has not been received, the ASM may transmit a query to the service facilitation system to determine if there is a pending service request associated with the transaction card. In such embodiments, the service facilitation system may then transmit requested service information to the ASM in response.

At 1400, the ASM transmits a verification request to the service facilitation system. This request may be transmitted directly to the service facilitation system or, in some embodiments, via the ASM administrator system. The verification request includes some or all of the card information and may include, in particular, a card-encrypted information block. The service facilitation system may use the card information as primary authentication evidence that the transaction card associated with the user is present at the ASM location. This primary authentication may include decrypting the card-encrypted information block. At 1500, the service facilitation system transmits a request for a second authentication factor to the user device. As will be discussed, this may include a request for any of several authentication factors. In a typical embodiment and scenario, however, the requested factor(s) will be or include user device location information. At 1600, the user device transmits a second factor response including the requested authentication factors (e.g., user device location information). The service facilitation system uses the secondary authentication information to assure that authentication/authorization criteria are met. In particular embodiments, this may include verification that the user device is co-located with the ASM and the transaction card. Upon successful authentication/authorization, the service facilitation system transmits an instruction to the ASM to initiate delivery of the requested service to the requesting user.

Embodiments of the invention will now be described in more detail. As noted above, the action or service processing system 100 may include a number of network-enabled computer systems, including, one or more ASMs 140, one or more ASM administrators 160, and a service facilitation data processing system 150 in communication with one another via a communication network 130. In typical embodiments, the system 100 may comprise many ASMs 140 under the administration of a single or multiple ASM administrators 160.

As referred to herein, a network-enabled processor, computer system or device may include, but is not limited to any computer device, or communications device including, a server, a network appliance, a personal computer (PC), a workstation, and a mobile processing device such as a smart phone, smart pad, handheld PC, or personal digital assistant (PDA). Mobile processing devices may include Near Field Communication (NFC) capabilities, which may allow for communication with other devices by touching them together or bringing them into close proximity.

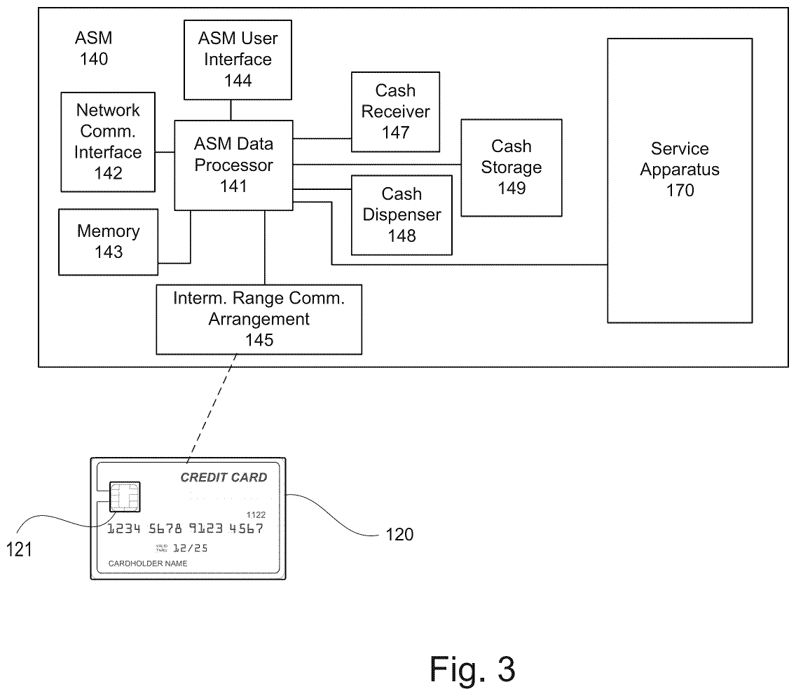

The network-enabled computer systems used to carry out the methods contemplated by the invention may execute one or more software applications to, for example, receive data as input from an entity accessing the network-enabled computer system, process received data, transmit data over a network, and receive data over a network. The one or more network-enabled computer systems may also include one or more software applications to send notifications to an account holder or other user. In some examples, computer systems and devices may use instructions stored on a computer-accessible medium (e.g., a storage device such as a hard disk, floppy disk, memory stick, CD-ROM, RAM, ROM, etc., or a collection thereof). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein. It will be understood that the depiction in FIG. 3 is an example only, and the functions and processes described herein may be performed by any number of network-enabled computers. It will also be understood that where the illustrated system 100 may have only a single instance of certain components, multiple instances of these components may be used. The system 100 may also include other devices not depicted in FIG. 1.

The network 130 may be any form of communication network capable of enabling communication between the transaction entities of the transaction monitoring system 100. For example, the network 130 may be one or more of a wireless network, a wired network or any combination of wireless network and wired network. The network 130 may be or include one or more of a fiber optics network, a passive optical network, a cable network, an Internet network, a satellite network, a wireless LAN, a Global System for Mobile Communication (“GSM”), a Personal Communication Service (“PCS”), a Personal Area Network (“PAN”), Wireless Application Protocol (WAP), Multimedia Messaging Service (MMS), Enhanced Messaging Service (EMS), Short Message Service (SMS), Time Division Multiplexing (TDM) based systems, Code Division Multiple Access (CDMA) based systems, D-AMPS, Wi-Fi, Fixed Wireless Data, IEEE 802.11b, 802.15.1, 802.11n and 802.11g or any other wired or wireless network for transmitting and receiving a data signal. The network 130 may utilize one or more protocols of one or more network elements to which it is communicatively coupled. The network 130 may translate to or from other protocols to one or more protocols of network devices. Although the network 130 is depicted as a single network, it will be appreciated that it may comprise a plurality of interconnected networks, such as, for example, the Internet, a service provider's network, a cable television network, corporate networks, and home networks.

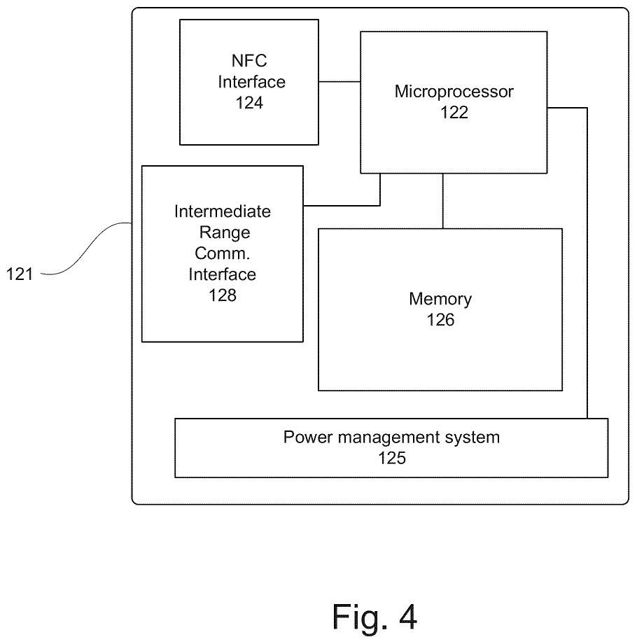

FIG. 4 is a schematic representation of an exemplary ASM 140. The exemplary ASM 140 includes an ASM data processor 141 and a user interface 144 that is configured for receiving information from and displaying information to an ASM user. The user interface 144 may include any device for entering information and instructions into the ASM, such as a touch-screen, keyboard, cursor-control device, microphone, stylus, or digital camera. The user interface 144 may also include a display, which can be any type of device for presenting visual information such as a computer monitor, a flat panel display, and a mobile device screen, including liquid crystal displays, light-emitting diode displays, plasma panels, and cathode ray tube displays.

The exemplary ASM 140 may include either or both of a cash receiver arrangement 147 and a cash dispenser 148. The cash receiver arrangement 147 may be any mechanism configured for securely receiving cash from a user, determining an amount of cash received, and depositing the cash into a secure cash storage arrangement 149. In some embodiments, the cash receiver arrangement 147 may also be configured for receiving and scanning checks or other documents required for processing an ASM transaction and/or obtaining an automated service. The cash dispenser 148 may be any mechanism configured for drawing a specified amount of cash from a cash storage arrangement 149 and dispensing it to an authorized ASM user.

In some embodiments, the ASM 140 may include a service apparatus 170 in communication with the ASM data processor 141. The service apparatus 170 may be or comprise any machine for providing an automated service. This could include, for example, the conventional machinery for an automatic car wash or a machine for exchanging coins for paper currency. The operation of the service apparatus 170 may be controlled by the ASM data processor 141 and may make use of the cash receiver 147 and cash dispenser 148 for product or service purchase transactions. In some embodiments, the service to be provided is, itself, reception of cash for deposit into a user's account, which may not require additional service apparatus 170.

The ASM 140 includes an ASM data processor 141 configured to communicate over the network 130 via a network communication interface 142. The ASM data processor 141 is in communication with a memory 143, which has stored therein information associated with the operation of the ASM 140. This may include identification information (e.g., an ASM identifier) and/or location information. The memory 143 may also have applications installed therein with instructions for carrying out service vending and reporting operations. This may include, for example, an application configured for processing machine services or product purchases and providing instructions to the service apparatus 170. It may also include transmitting transaction information to an ASM administrator 160.

The ASM memory 143 may, in particular, have a service transaction application stored therein that is configured for facilitating the provision or initiation of a user-requested service without direct interaction with the user. This service application may include instructions for the ASM data processor 141 to receive a service request notification from a service facilitation system 150. This notification may be received directly from the service facilitation system 150 via the network 130 or may be received from the service facilitation system 150 via the ASM administrator 160. The service request notification may include service request information for a service requested by a card account holder associated with a particular transaction card 120. The service request information may include identification of a desired service and any additional information required by the ASM 140 to provide the desired service. In some embodiments, the service request information may specify a time interval within which the user will arrive at the ASM 140 to receive the service. The service request information may also include information associated with the transaction card 120. In particular, this may be or include a card identifier or other information sufficient to distinguish the card 120 for the requesting account holder from other cards 120.

The service transaction application may include instructions for establishing non-network wireless communication with a user device 110 and/or a smart transaction card 120 of an account holder. In some embodiments, the application may be configured to accomplish this through the use of an intermediate range, wireless and touchless communication arrangement 145. In particular embodiments, the wireless communication arrangement 145 includes a radio frequency identification receiver (or transceiver) 146 capable of operation according to ISO 15693. The receiver 146 may be configured to establish wireless communication with a corresponding intermediate range transmitter when the transmitter is brought to within a range of about 1.5 m. or less. In some embodiments, the arrangement 145 may include an NFC receiver or transceiver as well or, alternatively, a single receiver/transceiver that is capable of switching between frequency modes to allow communication in either NFC mode or ISO 15693 mode.

The wireless communication arrangement 145 may be configured, in particular, for establishing wireless communication with a transaction card 120 configured for intermediate range wireless communication. In particular embodiments, the service transaction application may include instructions for the ASM data processor 141 to receive transaction card information upon establishing communication with a transaction card 120 via the wireless communication arrangement 145. This transaction card information may include identification information that can be compared to information previously received in a service request notification. In some embodiments, the service application may be configured to, upon determining that the transaction card 120 in communication with the ASM 140 (and therefore is co-located with the ASM 140) is the card 120 associated with the service requester's account, initiate provision of the requested service.

Alternatively or in addition, the transaction card information may include validation information that can only be validated by a card administrator and/or a service facilitation system 150. Such information could include, for example, an information block encrypted by the transaction card 120. In such embodiments, the service transaction application may include instructions for the ASM data processor 141 to construct and transmit a verification request to the service facilitation system 150. This request may include ASM identification information and card identification information and/or the validation information. The service transaction application may be configured to receive a verification response message, which may include instructions to initiate the requested service. Upon receiving such a response message, the application may cause the ASM data processor 141 to initiate the service or, if applicable, to cause the service apparatus 170 to initiate the service.

In the above described embodiments, the service request notification is received by the ASM 140 prior to arrival of a user at the location of the ASM 140. In some embodiments, however, the ASM 140 may be configured to, upon establishing wireless communication with a transaction card 120 and determining that no service request notification associated with the transaction card 120 has been received, transmit a query to the service facilitation system 150 identifying the transaction card to determine if a service is to be provided without communication with the card holder. Such a service may be the subject of a pending service request or may be established through contemporaneous communication between the service facilitation system 150 and the transaction card account holder. The service transaction application of the ASM 140 may be configured to receive a service request notification in response to this query. In some embodiments, a verification response may be received at the same time.

In some embodiments, the service transaction application may be configured for further authentication of a service request. This may include configuration for receiving multi-factor authentication information from the user device 110 and/or directly from a user via the user interface 144. In some embodiments, authentication may include receiving an ASM transaction authentication code from the service facilitation system 150 and presenting that code to the requesting account holder using a display of the user interface 144. The code could then be transmitted by the user device 110 to the service facilitation system 150 for authentication. Alternatively, authentication instructions may include instructions to capture a digital image of a purported authentication code and transmitting the purported authentication code to the service facilitation system 150 for secondary authentication.

Regardless of the specific method for authentication, the service transaction application may be further configured to, upon authentication, receive instructions from the service facilitation system 150 to carry out the requested service. The service transaction application may be further configured to transmit transaction completion information to the ASM administrator 160 and/or the service facilitation system 150.

It will be understood that various ASMs 140 may have different service capabilities and/or capacities. While all may have the same network and local communication capabilities, the services they provide may be substantially different. For example, some of the ASMs 140 may be able to receive cash and coins while others are not. Some may have limited or no user interface features and/or may be configured for receiving instructions and user information via network connection to an account holder user device 110. Some may be configured for providing a mechanical service (e.g., a car wash) while others are configured only for providing financial services.

In the example embodiments presented herein, an account holder may be any individual or entity having a service transaction account. An account may be represented by any object, entity, or other mechanism for holding money or performing transactions in any form, including, without limitation, electronic form. An account may be, for example, a card account (e.g., a prepaid card account, stored value card account, debit card account, check card account, payroll card account, gift card account, prepaid credit card account, or charge card account) having one or more transaction cards 120 associated therewith.

The transaction card 120 may be any device having a processor configured for carrying out digital transactions and having a memory in which identification and encryption information can be permanently stored. This may include chip-carrying transaction cards (“smart” cards), and mobile and non-mobile user computing devices. As illustrated in FIGS. 3 and 4, a typical transaction card 120 that is usable in various embodiments of the invention is a smart card with a microprocessor chip 121. The microprocessor chip 121 includes processing circuitry for storing and processing information, including a microprocessor 122 and a memory 126. It will be understood that the processing circuitry may contain additional components, including processors, memories, error and parity/CRC checkers, data encoders, anticollision algorithms, controllers, command decoders, security primitives and tamper-proofing hardware, as necessary to perform the functions described herein. In some embodiments, the chip 121 may include a power management system 125, which may include a power source (e.g., a battery, capacitor, photovoltaic cell, kinetic or piezoelectric power scavenger, etc.) and circuitry for managing and distributing power to the components of the chip 121.

The microprocessor chip 121 may further include one or more wireless communication interfaces configured for short or intermediate range wireless communication. In the illustrated embodiment, the chip 121 includes an NFC interface 124, which may comprise an NFC transmitter configured for establishing near field communication with a corresponding NFC receiver or transceiver. The chip 121 also includes an intermediate range communication interface comprising an intermediate range radio frequency transmitter configured for operation in accordance with ISO 15693. Transaction cards so equipped may be referred to herein as “vicinity cards”. In some embodiments, the chip 121 may comprise a single wireless communication interface configured for both near field and intermediate field (vicinity) communication and capable of switching between the two. In some embodiments, the microprocessor chip 121 may include circuitry configured for communication via other means such as Bluetooth, satellite, Wi-Fi, wired communications, and/or any combination of wireless and wired connections.

In particular embodiments, the memory 126 of the microprocessor chip 121 may have stored therein instructions for generating encrypted information and transmitting it to a receiving device (e.g., an ASM 140) via the intermediate range communication interface 128. Such encrypted information may be or include an encrypted verification block or signature that may be used by a service facilitation system 150 to authenticate and verify the presence of the transaction card 120 at the location of a particular ASM 140). In some embodiments, the memory 126 may have stored therein one or more card-unique keys usable to generate single-use passwords or signatures that can only be decrypted by a system having access to such keys.

The NFC interface 124 and the microprocessor 122 may, in particular, be configured for establishing communication with merchant transaction processing devices for carrying out purchase and other transactions. The NFC interface 124 may be configured to provide for contact-based communication, in which case the interface 124 may have electrical circuitry and contact pads on the surface of the card 120 for establishing direct electrical communication between the microprocessor 122 and the processing circuitry of a transaction terminal (e.g., ASM 140). Alternatively or in addition, the NFC interface 124 may be configured for contactless communication with the transaction terminal.

The card chip memory 126 may be a read-only memory, write-once read-multiple memory or read/write memory, e.g., RAM, ROM, and EEPROM, and the chip 121 may include one or more of these memories. The memory 126 may have stored therein information associated with a transaction card account. In some embodiments, the memory 126 may have permanently stored therein a unique alphanumeric identifier associated with the account. It may also have stored public and/or private card encryption keys. In some embodiments, the private and public encryption keys may be permanently hard-wired into the card memory.

The memory 126 may be configured to store one or more software applications for execution by the microprocessor 122. In various embodiments, the memory 126 may have stored therein instructions for generating encrypted information and transmitting it to a receiving device (e.g., the ASM 140) via the intermediate range communication interface 128. Such encrypted information may be or include an encrypted verification block or signature that may be used to authenticate and verify the presence of the transaction card 120 during transaction processing.

In particular embodiments of the invention, the card memory 126 may include an application including instructions configured for establishing intermediate range communication when the transaction card 120 is brought within intermediate communication range of an intermediate range wireless communication receiver (e.g., receiver 146 of ASM 140) and, upon establishing such communication, transmitting transaction card information to the receiver. this information may include a card identifier and/or validation information that can only be validated by a card administrator and/or a service facilitation system 150. Such information could include, for example, an information block encrypted by the transaction card 120.

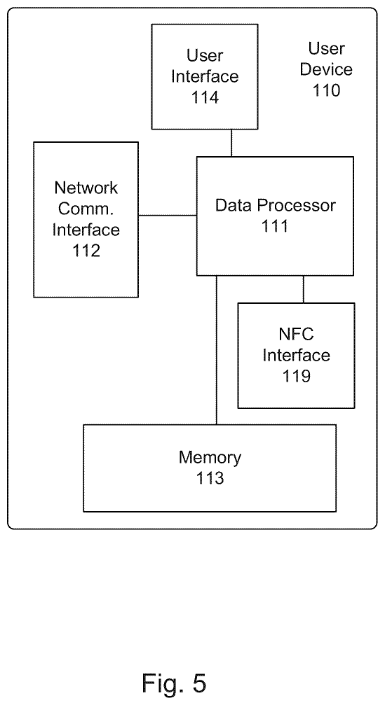

With reference to FIG. 5, an account holder (or other user) processing device 110 may be any data processing and/or communication device that an account holder uses to carry out a transaction and/or to communicate with a transaction processing authority or the service facilitation system 150 including, but not limited to a smartphone, a laptop, a desktop computer, and a tablet. In particular embodiments, the user device 110 is a mobile device having an on-board data processor 111 in communication with a memory module 113, a user interface 114, and a network communication interface 112. The device 110 may also include an image capturing device (e.g., a digital camera or scanner). The data processor 111 can include a microprocessor and associated processing circuitry, and can contain additional components, including processors, memories, error and parity/CRC checkers, data encoders, anticollision algorithms, controllers, command decoders, security primitives and tamper-proofing hardware, as necessary to perform the functions described herein. The memory 113 can be a read-only memory, write-once read-multiple memory or read/write memory, e.g., RAM, ROM and EEPROM, and the user device 110 can include one or more of these memories.

The user interface 114 includes a user input device or mechanism, which can be any device for entering information and instructions into the user device 110, such as a touch-screen, keyboard, mouse, cursor-control device, microphone, stylus, or digital camera. The user interface 114 may also include a display, which can be any type of device for presenting visual information such as a computer monitor, a flat panel display, and a mobile device screen, including liquid crystal displays, light-emitting diode displays, plasma panels, and cathode ray tube displays.

The network communication interface 112 is configured to establish and support wired or wireless data communication capability for connecting the device 110 to the network 130 or other communication network. The user device 110 may also include an NFC interface 119 that can be configured to support near field communication with an NFC transmitter/receiver. The NFC interface 119 may, in particular, be configured for near field communication with a chip-mounted NFC device of a smart transaction card 120.

In embodiments of the invention, the memory 113 may have stored therein one or more applications usable by the data processor 111 to conduct and/or monitor transactions between the user device 110 and a merchant device or transaction processing system over the network 130. These applications may include instructions usable by the data processor 111 to identify transaction events, store event data in the memory 113, and communicate event data to a transaction processor.

In certain embodiments, the memory 113 may have stored therein a service transaction application for requesting a service at an ASM 140. This application may include instructions to receive information from the user via the user interface 114 regarding a service transaction the account holder wishes to complete using an ASM 140. This information may include identification of desired service or selection of desired service from a list displayed to the user via the user interface 114. Depending on the service requested, the application may prompt the user to supply additional parameters required by the ASM 140 to initiate the service. The request information may also include identification of an ASM 140 or a selection of ASM 140 from a list received by the user device 110 from the service facilitation system 150. The application may further include instructions to use the user-supplied request information to construct and transmit a service transaction request to the service facilitation system 150. The transaction request may also include information identifying the user device, the account holder, the account, and/or the transaction card associated with the account. The service application may also be configured to receive a request response/confirmation from the service facilitation system 150, which may include information on times and availability of the service at the selected ASM 140. In some embodiments, the response may include proposed or alternative ASM locations that may be optionally selected by the account holder user.

The application may be further configured to instruct the data processor 111 to receive a second factor verification request over the network from the service facilitation system 150. This request will typically be transmitted by the service facilitation system 150 after the account holder has arrived at the ASM 140 and the account holder's transaction card 120 has transmitted card information to the ASM 140. The card information may be used for initial (primary) authentication by the service facilitation system 150. The second factor verification request may include a request or instructions for the user device data processor 111 to transmit at least one additional authentication factor usable by the service facilitation system 150 to verify that secondary authentication criteria are met. In some embodiments, the secondary authentication factor(s) may be or include login and/or password information entered by the user within a predetermined time interval before or after arrival within card communication range of the ASM 140, In other embodiments, the secondary authentication factor(s) may be or include an account holder biometric characteristic scanned or otherwise captured by the user device within a predetermined time interval before or after arrival within card communication range of the ASM 140, In particular embodiments, the secondary authentication factor(s) may be or include a location of the user device 110. This may be obtained by the data processor 111 through the use of a GPS or other location application.

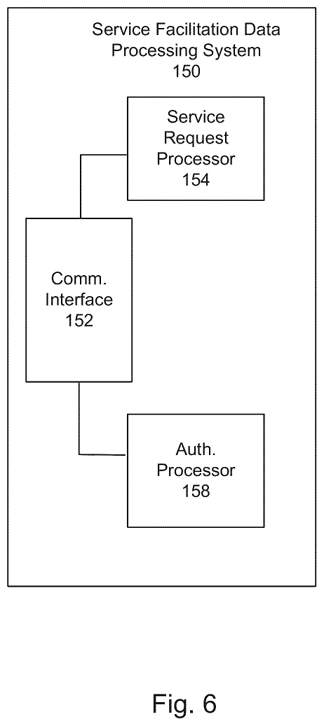

With reference to FIG. 6, the service facilitation data processing system 150 is a network-enabled processing system configured for communication with one or more account holder user devices 110 and each of the plurality of automated service machines 140, either directly via the network 130 (or other network) or via the network 130 and an ASM administrator 160. The service facilitation system 150 may include a secure communication interface 152 in data communication with the network 130 and configured to receive communications from the user devices 110 and the ASMs 140. In some embodiments, the communication interface 152 may be configured to provide an initial security screen to validate such communications. In some embodiments, the communication interface may be configured to communicate with the user device 110 via a first network (e.g., network 130) and the ASMs 140 via a second network.

The service facilitation system 150 further includes a service request processor 154 that is configured for receiving ASM service requests from account holder-associated user devices 110. A service request may be received as a separate, standalone request (e.g., an email request) or may be made as part of an on-line interactive session between the user device 110 and the service facilitation system 150. In particular embodiments, the request may be transmitted by the user device 110 using a service request application resident on the user device 110.

As discussed above, an ASM service request may include identification information usable by the request processor 154 to identify the user device and/or the vicinity card account with which the user device 110 is associated. The request may further include information about a service the account holder wishes to obtain using an ASM 140. This may include information indicating the type of service and desired parameters/characteristics of the service. In some embodiments, it may also include information relating to or identifying a particular ASM 140.

The request processor 154 may be configured to conduct an initial authorization verification to assure that the user device 110 and/or the user are authorized to request and obtain the requested service. This may be based on verification of user-supplied authorization information (e.g., login information). In some embodiments, initial verification may be established based on the user having logged in through an account-related application on the user device 110.

The service request processor 154 may be configured to process a service request by retrieving ASM information from an ASM database 180 and comparing it to the information provided by the user in the service request. The ASM database 180 may include an ASM data record for each ASM 140 in the ASM network. The data record may include such information as a machine identifier, location of the ASM 140, merchant outlet association, accessibility limitations, transaction capabilities or limitations, and administrator information. In some cases, some or all of the candidate ASMs 140 may be managed by a separate third party ASM administrator 160. In such cases, information for an ASM 140 so-managed may be obtained by the service facilitation system 150 from the ASM administrator 160 and stored in the ASM database 180 at the time the ASM 140 is added to the system 100.

If the service request specifies a particular ASM 140, the service request processor 154 may compare the requested service parameters to capability and status information obtained from the ASM database 180 for the requested ASM 140 to determine an availability result (i.e., a determination that the ASM 140 is available and capable of providing the requested service). In some embodiments, if a particular ASM 140 is not specified, the service request processor 154 may construct a list of candidate ASMs 140 within the vicinity of the user device 110 that can provide the requested service. The service request processor 154 may be configured to determine a best candidate ASM 140 based on predetermined selection criteria and/or candidate availability information. Information on the candidate ASM 140 may then be sent to the user device 110. Alternatively, the service request processor 154 may be configured to transmit the set of ASM candidates to the user device 110 for display to the account holder. In either case, the processor 154 may be configured to receive a response from the user device 110 that includes either approval of a suggested ASM 140 or a selection of a particular ASM 140 from a list of candidates.

Whether the “requested” ASM 140 is determined from the initial service request or selected or approved by the user in a subsequent response, the request processor may transmit a service request notification to the transaction ASM 140 and/or the ASM administrator 160. The service request notification may include some or all of the information received in the service request. The service notification information may include identification of the desired service and any additional information required by the ASM 140 to provide the desired service. In some embodiments, the service request information may specify a time interval within which the account holder expects to arrive at the ASM 140 to receive the service. The service request information may also include information associated with the vicinity transaction card 120 or the card account. In particular, this may be or include a card identifier or other information sufficient to distinguish the service requester's transaction card 120 from other cards 120.

The authentication data processor 158 is a network-enabled processing system that may be configured to assure the presence of an authorized account-holder transaction card at the ASM location when the requested automated service transaction is processed. The authentication data processor 158 is configured to receive a service verification request from the ASM 140, either directly or via the ASM administrator 160. The service verification request includes card authentication information, which may include either or both of a card identifier and validation information, typically in the form of a card-encrypted authentication block. The authentication data processor 158 may be configured to use the card authentication information as a primary authentication for the requested service. This may include retrieving card and account information for the requesting account holder's account from a card account database 190 and comparing. The authentication data processor may be configured to compare the received card identifier to the identifier for the card 120 associated with the account. In embodiments where the verification request includes an encrypted authentication block, the retrieved card account information may include one or more encryption keys usable by the authentication data processor 158 to decrypt the encrypted authentication block. In particular embodiments, the retrieved card information may also include a counter that can be used to determine a single-use session key for decrypting the authentication block. Upon use, this counter may be decremented and restored in the card account database. It will be understood that successful decryption of the encrypted authentication block may itself be sufficient for primary verification that the card presented at the ASM 140 is the card account vicinity card associated with the requester's account. Further validation may be obtained by comparison of the decrypted content to information from the card account database 190.

In some embodiments, the authentication data processor 158 may be configured to obtain secondary authentication information to further authenticate the service transaction request. In some such embodiments, the authentication data processor 158 may be configured to verify that the account holder is or has recently (i.e., within a predetermined time interval) logged in using can account-associated application on the user device 110. In other embodiments, the authentication data processor 158 may be configured to transmit a request for one or more secondary authentication credentials to the account holder user device. This could include, for example, login information or a biometric characteristic determined by the user device 110 contemporaneously or within a predetermined time interval preceding the request. Upon receiving the secondary authentication credential(s) from the account holder user device 110, the authentication data processor 158 may use it to establish a secondary authentication result for the service request (e.g., by comparison to information retrieved from the account database 190).

In some embodiments, the authentication data processor 158 may be configured to transmit a request for geolocation information from the account holder user device 110. Upon receiving this information from the account holder user device, the authentication data processor may determine a location of the account holder user device using the geolocation information and compare it to the location of the requested ASM 140. In some embodiments, the authentication data processor 158 may determine a separation distance between the account holder user device 120 and the requested ASM 140 and compare it to predetermined proximity criteria to determine whether the user device 120 is close enough to the ASM 140 to authorize the requested service.

The authentication data processor 158 may be configured to determine an overall service authorization result for the requested service based on a combination of one or more of the above determinations (i.e., a primary authentication result based on verification of the presence of the transaction card 120 associated with the requester's account, a secondary authentication result based on user device-provided authentication information, and, if appropriate, an availability result for the requested ASM 140). If all applicable determinations are positive, the authentication data processor 158 establishes a positive service authorization result and transmits an instruction to the requested ASM 140 to initiate the requested service. If any of the determinations are not positive, the authentication data processor 158 may establish a negative service authorization result. In some embodiments, the authentication data processor 158 may transmit to the ASM 140 and/or the user device 110 a service declined message, which may include a reason for declining to authorize the requested service.

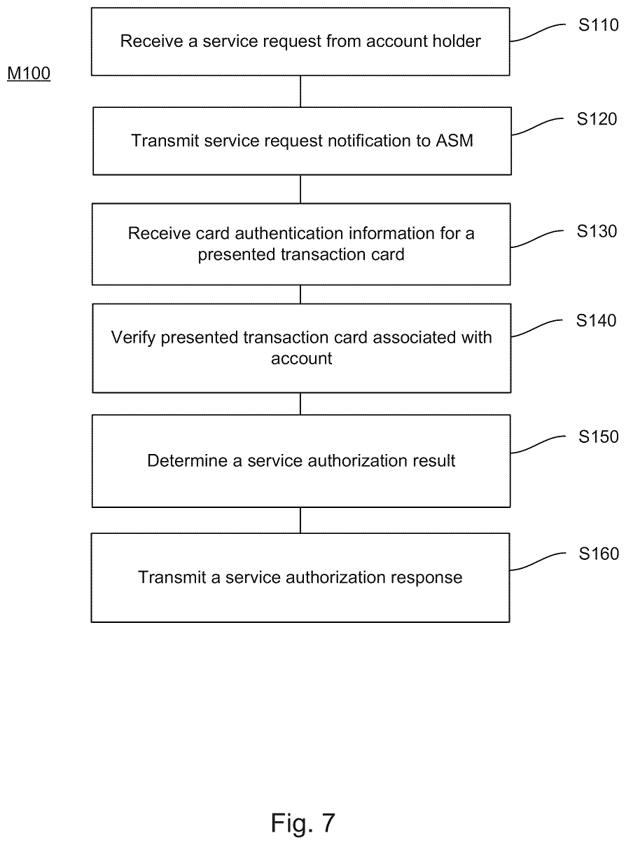

Service facilitation processing systems of the invention may be used to carry out various service request authentication methods. FIG. 7 illustrates actions in an illustrative method M100 for authorizing an automated service according to an embodiment of the invention. At S110 of the method M100, a service facilitation data processing system (e.g., data processing system 150 of system 100) receives a service request from an account holder user device (e.g., user device 110 of system 100) associated with a transaction card account and a card account vicinity card (e.g. card 120 of system 100). The service request may be received as a separate, standalone request (e.g., an email request) or may be made as part of an on-line interactive session between the account holder user device and the service facilitation system. The service request may include identification of some, any or all of the user device, the transaction card account, the account holder associated with the transaction card account, and the card account vicinity card. The request may also include identification of an ASM (e.g., ASM 140 of system 100) and a service to be provided by the ASM. The latter may include information indicating the type of service and desired parameters/characteristics of the service.

At S120, the service facilitation data processor transmits a service request notification to the requested ASM. The service request notification may include some or all of the service request information. Typically, this will include identification of the requested service and any additional information required by the ASM to provide the service. In some embodiments, the service request information may specify a time interval within which the user will arrive at the ASM to receive the service. The service request information may also include information associated with the card account vicinity card. In particular, this may be or include a card identifier or other information sufficient to distinguish the card account vicinity card from other transaction cards.

At S130, the service facilitation data processor receives, from the requested ASM, card authentication information received from a vicinity card presented at the ASM. This may include card identification information and/or an encrypted authentication block received by the ASM from the presented vicinity card. At S140, the service facilitation data processor uses the card identification information to verify that the presented vicinity card is the card account vicinity card. In some embodiments, this may include retrieving card and account information for the requesting account holder's account from a card account database and comparing a received card identifier to the identifier for the card account vicinity card. In embodiments where the verification request includes an encrypted authentication block, the action at S140 may include decrypting the encrypted authentication block. It will be understood that successful decryption of the encrypted authentication block may itself be sufficient for primary verification that the card presented at the ASM is the card account vicinity card. Further validation may be obtained by comparison of the decrypted content to information from a card account database.

At S150, the service facilitation data processor determines a service authorization result for the requested service. In some embodiments this may be based, at least in part, on the outcome of the of the card verification action at S140. In some embodiments, the determination at S150 may be based, at least in part, on a positive result of a secondary authentication action. This may include obtaining secondary authentication information from the user device associated with the account. This may be accomplished by transmitting, to the account holder user device, a request for at least one secondary authentication credential and receiving the requested credential(s) back from the user device. The requested credential could be or include a user biometric characteristic or a login credential received by the user device from the user. In either case, these may be compared to information stored in an card account database for the card account to determine a secondary authentication result.

In some embodiments, the action at S150 may include verification that the account holder user device is or recently has been within an acceptable distance of the requested ASM. this verification may include transmitting a request for geolocation information to the account holder user device and receiving the requested geolocation information from the account holder user device. The service facilitation data processor may then determine a location of the account holder user device using the geolocation information and determine a separation distance between the account holder user device and the location of the ASM. This separation distance can then be compared to predetermined proximity criteria to determine if the separation is acceptable for authorization of the requested service.

In some embodiments, the action of determining a service authorization result at S150 may include determining a service risk factor indicative of a relative degree of risk associated with authorization of the requested service. The relative degree of risk may be based on a determination of a time interval since a most recent login into an account application associated with the card account, a determination of a time interval since a most recent transaction involving the card account, and/or a determination of a location of a most recent transaction involving the card account. Once a service risk factor is determined, it may be compared to predetermined risk factor criteria. The service facilitation data processor may then establish a positive service authorization result only upon the service risk factor meeting the predetermined risk factor criteria.

In some embodiments, the determination of an authorization result at S150 may include one or more actions to verify the authorization of the user, user device, or card account to obtain the requested service at the requested ASM. This may include using information from a card account database to verify that an account parameter status for the card account meets predetermined requirements for the requested service, verify that the card account itself is authorized for the requested service, and/or verify that the account holder user device is associated with a user who is authorized to request the requested service.

In some embodiments, the determination of an authorization result at S150 may include one or more actions to verify the requested ASM is available for use and is capable of providing the requested service. This may include comparing the requested service parameters to capability and status information obtained from an ASM database or from an ASM administrator.

At S160, the service facilitation data processor may transmit a service authorization response to the requested ASM. If the service authorization result is positive, the service authorization response may include an instruction for the ASM to initiate the requested service. If the service authorization result is negative, the response may instruct the ASM to decline the requested service.

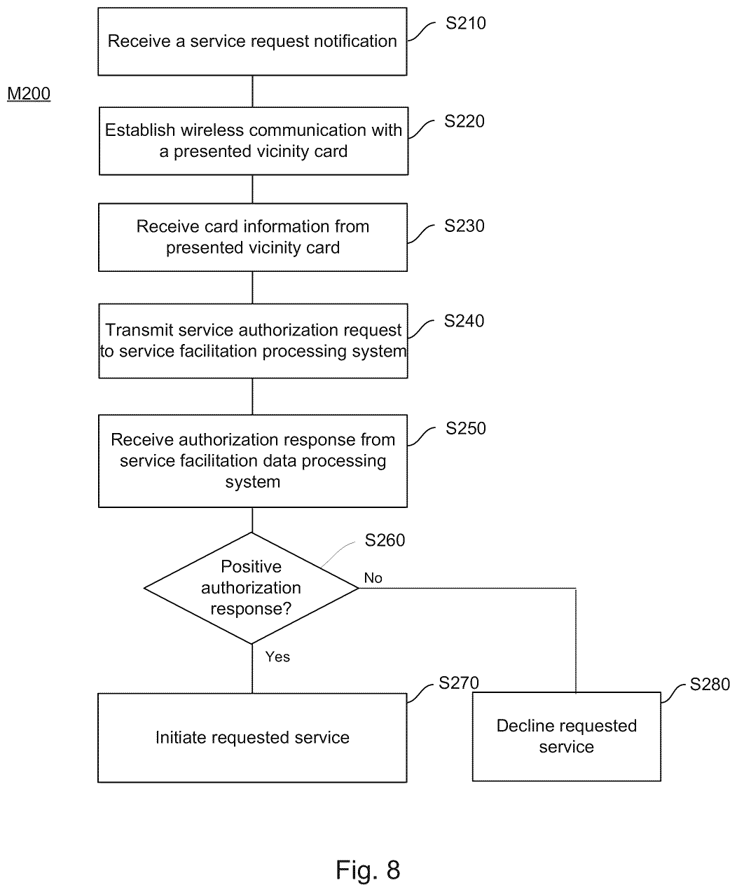

FIG. 8 illustrates actions in an illustrative method M200 for providing an automated service by an ASM (e.g. ASM 140 of system 100). At S210 of the method M200, the ASM receives a service request notification from a service facilitation data processing system. The service request notification may include a card account identifier associated with an account, an account holder device and a vicinity card. The service request notification may also include requested service information, which may identify a requested service and one or more service characteristics or parameters. In some embodiments, the ASM may determine that it is not currently capable of providing the requested service. In such embodiments, the ASM may transmit a response to the service facilitation data processor indicating that such is the case.

At S220, the ASM establishes contactless communication with a vicinity card presented at the ASM location. In particular embodiments, this communication is established through the use of a communication arrangement capable of intermediate range wireless communication in accordance with ISO 15693. In particular embodiments, intermediate range communication may be established upon the placement of an ISO 15693-enabled vicinity card within intermediate communication range of the ASM. The maximum such communication range may be 1.0 to 1.5 meters. At S230, the ASM receives presented card information from the presented vicinity card via the medium range communication. This may include a presented card identifier or card account identifier and an encrypted authentication block. The encrypted authentication block may be or include a single-use password encrypted by a micro-processor on the presented vicinity card. At S240, the ASM transmits a service authorization request to the service facilitation data processing system over a network. The service authorization request includes card authentication information usable by the service facilitation data processor to verify that the presented vicinity card is the vicinity card associated with the account. The card authentication information may be or include at least a portion of the presented card information including the encrypted authentication block. At S250, the ASM receives an authorization response from the service facilitation data processing system and at S260 the ASM determines if the response is positive or negative. If the response is a positive authorization response, the ASM initiates the requested service at S270. If the response is a negative authorization response, the ASM declines the service request at S280. As part of the declining action, the ASM may display a message to the card presenter indicating that the service is being declined. In some embodiments, the negative response may include a reason for the service being declined. In such embodiments, the ASM may also display this information.

It will be understood that the nature of a service requested and provided or facilitated in the above-described methods is limited only by the capabilities of the requested ASM. The present invention may be used to provide or facilitate provision of any service that is initiable and controllable by a network-enabled data processing system. The methods and system of the invention provide a significant improvement to current interactions with automated service machines. The invention allows a user to obtain a service from such machines without contact or very close (e.g., NFC range) interaction. The invention also provides for enhanced security by providing for service request authentication, not only based on information from a smart vicinity card, but also from an associated user device that may be required to be co-located with the card and the ASM.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

What is claimed is:

1. An automated method of authorizing an automated service, the method comprising:
receiving, by a service facilitation data processing system from an account holder user device, a service request including identification of an automated service machine (ASM) and a service to be provided by the ASM, the account holder user device being associated with a card account and a card account vicinity card;
transmitting, by the service facilitation data processing system to the ASM, a service request notification including a card account identifier associated with the vicinity card and requested service information;
receiving, by the service facilitation data processing system from the ASM, card authentication information including an encrypted authentication block received by the ASM from a presented vicinity card;
verifying, by the service facilitation data processing system using the card authentication information, that the presented vicinity card is the card account vicinity card;
determining, by the service facilitation data processing system, a service authorization result for the requested service;
transmitting, by the service facilitation data processing system to the ASM, a service authorization response based, at least in part, on the service authorization result.

2. An automated method according to claim 1, wherein the action of transmitting a service request notification is carried out after the action of receiving card authentication information.

3. An automated method according to claim 1, wherein the action of determining a service authorization result includes at least one of the set consisting of
verifying an account parameter status for the card account meets predetermined requirements for the requested service,
verifying that the card account is authorized for the requested service, and
verifying that the account holder user device is associated with a user who is authorized to request the requested service.

4. An automated method according to claim 1, wherein the action of determining a service authorization result includes:
transmitting, to the account holder user device, a request for at least one secondary authentication credential;
receiving, from the account holder user device, the at least one secondary authentication credential; and
determining the service authorization result, at least in part, using the at least one secondary authentication credential.

5. An automated method according to claim 4, wherein the at least one secondary authentication credential includes a user biometric characteristic for a user of the account holder user device and the action of determining the service authorization result includes:
retrieving an account holder biometric characteristic for an account holder associated with the card account; and
comparing the user biometric characteristic to the account holder biometric characteristic.

6. An automated method according to claim 4, wherein the at least one secondary authentication credential includes a login credential provided through an account application on the account holder user device.

7. An automated method according to claim 1, wherein the action of determining a service authorization result includes:
transmitting a request for geolocation information to the account holder user device,
receiving the requested geolocation information from the account holder user device,
determining a location of the account holder user device using the geolocation information,
determining a separation distance between the account holder user device and the ASM, and
determining whether the separation distance meets predetermined proximity criteria for the requested service.

8. An automated method according to claim 1, wherein the action of determining a service authorization result includes:
determining a service risk factor indicative of a relative degree of risk associated with authorization of the requested service;
comparing the service risk factor to predetermined risk factor criteria; and
establishing a positive service authorization result only upon the service risk factor meeting the predetermined risk factor criteria.

9. An automated method according to claim 8, wherein the action of determining a service risk factor includes at least one of the set consisting of:
determining a time interval since a most recent login into an account application associated with the card account;
determining a time interval since a most recent transaction involving the card account; and
determining a location of a most recent transaction involving the card account.

10. An automated method according to claim 1, wherein the action of verifying that the presented vicinity card is the card account vicinity card includes:
determining a card-unique encryption key for the vicinity card;
constructing a transaction-unique session key using the card-unique encryption key; and
decrypting the encrypted authentication block.

11. A service facilitation data processing system for facilitating a service transaction on a vicinity card account at one of a plurality of automated service machines (ASMs), the system comprising:
a communication interface configured for selective communication with any of the plurality of ASMs via a first network and an account holder user device associated with the vicinity card account via a second network,
a service request data processor configured to
receive, from the account holder user device, a service request including identification of a requested ASM and a service to be provided by the requested ASM, the requested ASM being one of the plurality of ASMs, and
transmit, to the requested ASM, a service request notification including requested service information and a card account identifier associated with the vicinity card account and a card account vicinity card,
an authentication data processor configured to
receive, from the requested ASM, card authentication information received by the ASM from a presented vicinity card,
verify that the presented vicinity card is the card account vicinity card,
determine a service authorization result for the requested service, and
responsive to determining a positive service authorization result, transmit an instruction to the requested ASM to initiate the requested service.

12. A service facilitation data processing system according to claim 11, wherein the authentication data processor is further configured to, as part of the action to determine a service authorization,
transmit, to the account holder user device, a request for geolocation information,
receive, from the account holder user device the requested geolocation information,
determine a location of the account holder user device using the geolocation information,
determine a separation distance between the account holder user device and the requested ASM, and
determine whether the separation distance meets predetermined proximity criteria for the requested service.

13. A service facilitation data processing system according to claim 11, wherein the authentication data processor is further configured to, as part of the action to determine a service authorization,
transmit, to the account holder user device, a request for at least one secondary authentication credential,
receive, from the account holder user device, the at least one secondary authentication credential, and
determine the service authorization result using the at least one secondary authentication credential.

14. A service facilitation data processing system according to claim 11, wherein the card authentication information includes an encrypted authentication block and the authentication data processor is further configured to, as part of the action to determine a service authorization,
obtain encryption key information for the card account vicinity card from a card account information database;
decrypt the encrypted authentication block using the encryption key information to obtain card authentication information; and
use the card authentication information to confirm that the presented vicinity card is the card account vicinity card.

15. An automated method of providing an automated service, the method comprising:
receiving, by an automated service machine (ASM) from a service facilitation data processing system, a service request notification including a card account identifier associated with an account holder device and a vicinity card and requested service information;
establishing, by the ASM, contactless communication with a presented vicinity card;
receiving, by the ASM from the presented vicinity card, presented card information including a presented card identifier and an encrypted authentication block;
transmitting, by the ASM to the service facilitation data processing system, a service authorization request including at least a portion of the presented card information including the encrypted authentication block;
receiving, by the ASM from the service facilitation data processing system an authorization response; and
responsive to receiving a positive authorization response, initiating the requested service

16. An automated method according to claim 15, wherein the ASM is capable of intermediate range wireless communication in accordance with ISO 15693 and the action of establishing contactless communication occurs immediately upon the presented vicinity card being brought to within a maximum communication range of the ASM.

17. An automated method according to claim 16, wherein the maximum communication range is 1.0 to 1.5 meters.

18. An automated method according to claim 15, wherein the requested service is a cash transaction service.

19. An automated method according to claim 15, wherein reception of a positive authorization response is indicative of the account holder device being within a predetermined distance from the ASM.

20. An automated method according to claim 15, wherein the encrypted authentication block is or includes a single-use password encrypted by a micro-processor on the vicinity card.
